(19) United States
(12) Patent Application Publication
(10) Pub. No.: US 2004/0142166 A1
(43) Pub. Date: Jul. 22, 2004

(54) Self-adhesive protective article for painted car components subject to high mechanical stress

(75) Inventors: Nicolai Bohm, Hamburg (DE); Karsten Seitz, Buxtehude (DE)

Correspondence Address: Norris, McLaughlin & Marcus P.A., 30th Floor, 220 East 42nd Street, New York, NY, 10017, US

(73) Assignee: tesa AG, Hamburg (DE)

(21) Appl. No.: 10/704,245

(22) Filed: Nov. 7, 2003

(30) Foreign Application Priority Data
Nov. 8, 2002 (DE) 102 52 516.1

(51) Int. Cl. B32B 7/12; B32B 15/04

(52) U.S. Cl. 428/343; 428/355 EN; 428/354

(57) ABSTRACT

Self-adhesive article for the transit protection of painted car components such as, in particular, bumpers, which are subject to high mechanical stress, having a woven as backing material which is provided on one side in particular with a polyethylene-vinyl acetate self-adhesive composition.

The invention relates to a self-adhesive article for the transit protection of painted car components such as, in particular, bumpers, which are subject to high mechanical stress.

The painting of plastic car components such as bumpers or rearview mirror housings the same colour as the car is nowadays standard in the contemporary visual design of modern motor vehicles. A consequence of this is that these components are highly sensitive to scratching. The bumpers and rearview mirrors in particular are exposed parts of the car which can very easily be contacted. Car makers must therefore respond to the heightened quality awareness on the part of customers by effectively protecting these components on their route from painting via assembly in the car plant through to delivery to the customer, in order to forestall complaints.

In recent years attempts have therefore been made to transfer the method of masking using special, paint-compatible transit protection films, as employed successfully with freshly painted metal parts and described for example in DE 195 32 220 A1 or in EP 0 827 526 A1, to bumpers.

In the case of bumpers such masking is found problematic on account of the fact that they are unable to withstand the severe stresses which frequently occur when the cars are being manoeuvred, as a result of scraping along and of slight collisions, and do not provide an adequate protective effect. Moreover, the relatively stiff films can only be bonded to the highly curved bonding geometries of the bumpers and mirror housings with a large amount of creasing, leading in many cases, and promoted in particular by any gradual outgassing of solvents from the bumper plastic, to irreversible impressions of the creased structure in the sensitive paint.

An improved protective effect against impact loads is possessed, on the other hand, by foam pads which are bonded to the bumpers. In instances of scraping collision on, say, concrete pillars, however, the mechanical resistance offered by foams is low.

The main problem here, however, lies primarily in secure bonding. Experience has shown that the pads often fall off even under the influence of rain and thus on the one hand no longer provide any protective effect and on the other hand contaminate the environment. Adhesives, which provide more reliable bonding, are generally found not to be compatible with the paint, meaning that irreversible deformations must be accepted.

EP 0 979 254 B1 discloses, for bumper protection, a masking material based on a cellulose woven and equipped with a polyisobutylene self-adhesive composition. A backing of this kind offers good mechanical protection and the advantage of easy and straight hand tearability along the threads of the weave.

A disadvantage, however, is the polyisobutylene adhesive, which under the influence of moisture suffers such a severe loss of adhesion to motor vehicle paints that the masking material partially detaches from the substrate. On the one hand it can no longer be stuck on again, and on the other hand, in this form, it also no longer ensures any protection. Instead, under certain circumstances, it even leads to the destruction of the areas of paint to be protected, since in the slipstream it can strike against the paint and, together with sand picked up by the adhesive, can act like an abrasive.

EP 0 959 119 A1 describes a self-adhesive protective article composed of a film/web laminate. Although such an article offers a good protective effect against frictional loads, webs as set out therein generally have little extensibility, and so a laminate stressed in such a way can be applied only with considerable creasing, and therefore has little paint compatibility. Moreover, webs and laminates thereof with films are very difficult to tear straight-edged by hand, which makes manual processing more difficult.

Similar considerations apply to the masking material presented in DE 100 09 851 C2, which is composed of a non-woven or knitted textile backing, a perforated material or a foam and has been provided with polyisobutylene or polyethylene-vinyl acetate adhesive. Although a knitted substance is very flexible it is difficult to tear by hand.

It is an object of the invention to provide a transit protection article, for bumpers and other painted plastic exterior mounted components for cars, which does not exhibit the disadvantages of the prior art, or not to the same extent. The article ought in particular, on the one hand, to conform readily to curved surfaces and, on the other hand, to adhere reliably under weather conditions. At the same time the requirements are for a high degree of abrasion resistance and also for good processing by hand, i.e. without unusual auxiliary means, so that outstanding mechanical protection and practical handling are combined with excellent paint compatibility on the particularly sensitive paint of such components.

This object is achieved by means of a self-adhesive article as set down in the main claim. The subclaims relate to advantageous developments of the protective article and also to particular possible applications.

The invention accordingly provides a self-adhesive article for the transit protection of painted car components such as, in particular, bumpers, which are subject to high mechanical stress, having a woven as backing material which is provided at least, and preferably, on one side with a polyethylene-vinyl acetate self-adhesive composition.

The woven is preferably coated at from 20 to 200 g/m², more preferably at from 50 to 150 g/m², with self-adhesive composition based on polyethylene-vinyl acetate.

The width of the self-adhesive article is guided by the specific application. It can have the width of a normal adhesive tape (between 12 and 50 mm), as a protective article for motor vehicle bumpers between 50 mm and 250 mm, and up to two metres for large-area applications.

Wovens are structures in which the sheet is produced by the crossover at right angles of two thread systems (warp threads and weft threads). They can be clearly delimited by definition from the nonwovens (bonded fibre materials), in which a loose fibre web is consolidated by means of heat, needling or stitching or by means of water jets, and formed-loop products, where one or more threads are joined by interlooping.

In another preferred embodiment the woven of the backing material is composed of a cotton or viscose rayon staple woven.

Examples of suitable fibre raw materials are natural fibres such as, in particular, cotton or viscose rayon staple, but also wool or silk, and also manufactured fibres such as cellulose acetate and blend fibres. It is also possible however, to use synthetic fibres made from addition polymers such as polyethylene, polypropylene and mixtures thereof, polyvinyl chloride, polyvinylidene dichloride or polyacrylnitrile, polycondensates such as polyamide, including aramid, or polyesters. Mention may also be made of inorganic fibres such as glass fibres.

The selection of material must take account of particular requirements imposed on the article, especially resistance to UV light for the duration of the application, and hand tearability.

For visual reasons the wovens may also have been dyed.

Of outstanding suitability in accordance with the invention are wovens having a basis weight of from 30 to 300 g/m², preferably from 80 to 180 g/m².

The choice of thread counts (warp thread and weft thread) is in principle arbitrary. What is important as regards the actualization of the invention is the ratio of thread count to linear fibre density. In accordance with the invention a woven is used which is sufficiently dense that the composition does not pass through it and which provides sufficient mechanical protection in the application.

Before or after being coated with the self-adhesive composition and/or with the pressure-sensitive adhesive, the woven can be treated, on the side facing the adhesive in the case of the single-sided coated embodiment, which is preferred, in order either to influence—generally to lower—the unwind force of the protective article when it is later wound up on itself to form a roll, or to impregnate it against moisture absorption.

This can be done using solutions, dispersions or reactive mixtures, the latter also called “one hundred per cent systems”, of active substances having deadhesive and/or hydrophobic properties. Particularly noteworthy are silicones and fluorinated polymers or mixtures of silicones and fluorinated polymers with polyacrylates or polyurethanes, the latter comprising both fully reacted polyurethane formulations and two-component reactive systems, into which the hydrophobic substances may have been mixed or in which the hydrophobic substances may have been incorporated chemically. Low molecular mass substances such as fats or waxes likewise are suitable. Another suitable deadhesive substance for regulating the unwind behaviour is polyvinyl stearylcarbamate.

The side of the backing material facing the adhesive can then be provided, in order to optimize the properties, with films and/or with known textile backings such as wovens, knits, non-crimp fabrics or nonwovens. In this case the backing material is composed of a two-ply or multi-ply laminate.

In order to obtain an improved bond between woven and adhesive it is possible optionally to treat the side of the woven facing the adhesive with an adhesion promoter before it is coated with the adhesive. Given suitable fibre raw materials, a physical pretreatment of the film, such as corona discharge or flame pretreatment, is also effective at improving the adhesion between woven and adhesive.

The self-adhesive article of the invention is coated with a base polymer of polyethylene-vinyl acetate (EVA) having a vinyl acetate fraction of from 40 to 90% by weight and, in one outstanding embodiment of the subject-matter of the invention, a melt index MFI according to ISO 1133 (A/4) of from 0.5 to 25 g/10 min at 190° C. and 2.16 kg.

Since the polymer framework in question is chemically uncrosslinked, and in view of its monomer ratio is only very slightly crystalline if at all, the molecular weight, which correlates directly with the MFI, adopts a decisive position in respect of the cohesiveness of the adhesive. An MFI of from 1 to 5 g/10 min at 190° C. and 2.16 kg has proved to be a favourable figure. The admixing of a fraction of the EVA with an MFI of up to 25, however, can contribute to improving the flow properties if the adhesive is being applied from the melt.

This adhesive base material is found to be weatherable outdoors for months without suffering decomposition; when applied to a woven it adheres with unexpected reliability to painted substrates even under damp environmental conditions, and can be detached therefrom again without residue.

Radiation crosslinking after the adhesive has been applied, in particular by means of electron beam curing, is a possibility for the purpose of raising the cohesion and of preventing contraction-induced residues.

In order to obtain supplementary desired properties it is possible for the adhesive to be blended with one or more additives such as tackifier resins, plasticizers, ageing inhibitors or fillers.

Examples of tackifiers resins for increasing the adhesive properties of the adhesives are hydrocarbon resins (composed, for example, of unsaturated C₅ or C₇ monomers), terpene-phenolic resins, terpene resins made from raw materials such as α-pinene or β-pinene, aromatic resins such as coumarone-indene resins or resins of styrene or α-methylstyrene, but preferably rosin and its derivatives such as disproportionated, dimerized or esterified resins, where glycols, glycerol or pentaerythritol can be used for the esterification, and also others as listed in Ullmanns Enzyklopädie der technischen Chemie, Volume 12, pages 525 to 555 (4th Edition), Weinheim. Particularly suitable are resins stable to ageing without olefinic double bond, such as hydrogenated resins, for example.

Examples of plasticizers, whose use is optional, include aliphatic, cycloaliphatic and aromatic mineral oils, diesters or polyesters of phthalic acid, trimellitic acid or adipic acid, polyethers and also liquid rubbers (for example nitrile rubbers or polyisoprene rubbers), liquid polymers of butene and/or isobutene, acrylic esters, polyvinyl ethers, liquid resins and soft resins based on the raw materials for tackifier resins, lanolin and other waxes or liquid silicones.

In order to make the adhesive even more stable to the effects of UV it is possible to add light stabilizers. Their function consists primarily in the prevention of the decomposition of the adhesive. Of particular suitability for the adhesive of the invention are HALS light stabilizers such as, for example, dimethyl succinate polymer with 4-hydroxy-2,2,6,6-tetramethyl-1-piperidineethanol (CAS No. 65447-77-0), bis(2,2,6,6-tetramethyl-4-piperidinyl) sebacate (CAS-No. 52829-07-9) or poly[[6-[(1,1,3,3-tetramethylbutyl)amino]-1,3,5-triazine-2,4-diyl][[(2,2,6,6-tetramethyl4-piperidyl)imino]hexamethylene[(2,2,6,6-tetramethyl-4-piperidyl) imino]] (CAS No. 70624-18-9).

Examples of suitable fillers and pigments are carbon black, titanium dioxide, calcium carbonate, zinc carbonate, zinc oxide, silicates or silica.

The self-adhesive article of the invention can be produced in a variety of ways.

On the one hand it can be produced by coating the woven from a solution of the adhesive of the invention or by coating from the melt, it being possible for the latter to take place by extrusion or by calendaring.

As a third way, the adhesive can be applied to the woven in a transfer process. In this case the adhesive is first applied from solution or as a melt to an intermediate backing and then joined to the woven by a laminating step.

The adhesive can be applied in one step, but also advantageously in two or more steps. In that way the layers of adhesive applied in different steps can fulfil different functions, by virtue of containing different additives.

For instance, the base application to the woven may be provided with a light-absorbing pigment, carbon black for example, and so protect the adhesive applied in further steps against direct radiation. Alternatively the concluding layer, which has contact with the substrate, can be blended with tackifier resins, while the base layer has no additives or different additives. Examples mentioned above do not constitute any restriction but instead are representative of all of the conceivable combinations which are within the concept of the invention.

In the case of painted plastic components having a high residual solvent content in the paint, owing to low drying temperatures for instance, it can be advantageous to perforate the article, in particular the adhesive, for the purpose of improved gas permeability.

The self-adhesive article can be produced not only in the form of a roll, i.e. rolled up on itself in the form of an Archimedean spiral, but also lined on the adhesive side with release materials such as siliconized paper or siliconized film. The latter is especially appropriate for producing adhesive diecuts shaped in accordance with the intended application.

A protective article of the invention in such an embodiment can be applied with little creasing and hence paint-compatibly to the generally curved surfaces of automotive plastic exterior mounted components such as a bumper. It is found to adhere securely even in wet weather conditions such as rain or fog. The ease of hand tearability, necessitating no additional tool for separation into lengths, ensures time-saving processing. The tearing site is smooth and straight-edged, thus forming no locations predestining the start of unwanted self-detachment.

From assembly through to dispatch of the finished vehicle to the customer, the protective article provides an excellent protective effect against scratches and accidental scraping along on obstacles.

The protective article can be removed without residue from the substrate even after a typical outdoor weathering time of six months. The painted plastic element to be protected then exhibits no permanent alterations such as discolorations or irreversible paint deformations.

In the vehicle interior as well the article designed in accordance with the invention is able to display its advantages: here too there are many surfaces to be protected temporarily or permanently against external effects.

The self-adhesive article of the invention is in no way whatsoever restricted in its application. It may serve to protect surfaces which are particularly sensitive to impact and scratching, such as paint, metal, plastic or glass surfaces, even outside the car industry.

The advantages are manifested fully whenever temporary protection under adverse conditions is desired.

The invention will be illustrated below with reference to examples, without wishing thereby to restrict it.

### EXAMPLES

### Example 1

A cotton woven (linear fibre density 200 dtex, thread count warp 30 1/cm, thread count weft 28 1/cm) is coated with the solution of a self-adhesive composition in toluene, consisting of a polyethylene-vinyl acetate having a vinyl acetate fraction of 60 per cent by weight, in two successive coating and drying operations so as to apply to the woven in the first operation 40 g/m² and in the second a further 80 g/m², i.e. 120 g/m² in all.

### Example 2

The protective article corresponds to that of Example 1 but differs in that a viscose rayon staple woven (linear fibre density 200 dtex, thread count warp 30 1/cm, thread count weft 28 1/cm) was used.

### Example 3

The protective article corresponds to that of Example 1 but differs in that the first coating and drying operation was carried out with the solution of a self-adhesive composition in toluene, consisting of a polyethylene-vinyl acetate having a vinyl acetate fraction of 60 per cent by weight, to which 10 per cent by weight of carbon black, based on the polymer fraction, had been admixed.

### Example 4

The protective article corresponds to that of Example 1 but differs in that the second coating and drying operation was carried out with the solution of a self-adhesive composition in toluene, consisting of a polyethylene-vinyl acetate having a vinyl acetate fraction of 60 per cent by weight, to which 20 per cent by weight, based on the polymer fraction of a perhydrogenated rosin pentaerythrityl ester having a softening point of 105° C. has been admixed.

### Example 5

The protective article corresponds to that of Example 1 but differs in that the reverse of the woven was impregnated after coating with polyurethane solution mixed with 5% of a polydimethylsiloxane oil.

### Example 6

The protective article corresponds to that of Example 1 but differs therefrom in that the entire adhesive was applied in a single operation using a melt roll calender.

### Comparative Example 1

The protective article corresponds to that of Example 1 but differs therefrom in that the solution of a polyisobutylene mixture of Oppanol B 10, Oppanol B 80 and Oppanol B 150 (BASF) in a 10:60:30 ratio in petroleum spirit of boiling fraction 60/95 was used.

### Comparative Example 2

The protective article corresponds to that of Example 1 but differs therefrom in that a water-jet-consolidated polyester nonwoven with a basis weight of 100 g/m² was used.

### Comparative Example 3

The protective article corresponds to that of Example 1 but differs therefrom in that a warp knit of nylon 6/6.6 with a mesh count of 14 meshes/cm in the machine direction and 14 mesh rows/cm in the cross direction, with a basis weight of 90 g/m², was used.

### Comparative Example 4

A polyethylene foam having a bulk density of 200 kg/m² and a thickness of 1.0 mm was coated with the adhesive used in Example 1 so as to give an application of 25 g/m².

Test Criteria

Four criteria which are particularly relevant from a performance standpoint for a protective article for motor vehicle exterior mounted components made of plastic were used for the comparative assessment of the example specimens:

1. Irreversible paint deformations beneath the overbonded area

2. Stability of attachment under wet weathering

3. Rubthrough resistance

4. Hand tearability

The test substrate selected comprised VW Golf IV bumpers with original paint finish. The specimens of the self-adhesive protective articles were cut to a length of 30 cm and a width of 15 cm and bonded to the corner parts of the bumper, which have a particularly high degree of three-dimensional curvature.

Test Procedures

1. Paint Deformations.

The bumper was overbonded with the test material and stored in a thermal chamber at 80° C. for three days. After cooling, the test specimen was removed and the bumper surface was assessed visually for irreversible changes in the surface quality of the paint.

The following scheme of points reflects the degree of deterioration of the paint:

0=invisible

1=barely visible

2=slightly visible

3=distinctly visible

2. Stability of Attachment Under Wet Weathering.

After a bonding time of one hour the bonded test specimens were transferred to conditions of 100% relative humidity and 40% heat and after 72 hours were assessed for detachment.

The extent of the detachments was assessed using the following scheme:

0=no detachment

1=slight detachment

2=severe detachment

3=specimen fell off

3. Rubthrough Resistance.

The test specimen was bonded to a metal plate and subjected to the action of a round test mandrel under a load of 3 kg in an abrasion tester at a frequency of 1 Hz until the mandrel made contact with the metal plate.

Evaluation Scheme:

0=more than 200 strokes

1=100 to 200 strokes

2=20 to 100 strokes

3=less than 20 strokes

4. Hand Tearability.

Three tears were made in each of the specimens, or attempts were made to make tears in the specimens, by three testing individuals transverse to the direction of winding. The average was formed from the total of nine subjective evaluations per sample. The evaluation scheme for the degree of hand tearability is as follows:

0=readily tearable

1=moderately tearable

2=difficult to tear

3=impossible to tear

Overview of Results

A low total points score (column Σ) denotes a good overall performance assessment.

| | | Stability of | | | |
|---|---|---|---|---|---|
| | Paint | attachment | | | |
| | deformation | under | Rubthrough | Hand | |
| | in area | moisture | resistance | tearability | Σ |
| Ex. 1 | 1 | 0 | 0 | 0 | 1 |
| Ex. 2 | 1 | 0 | 0 | 0 | 1 |
| Ex. 3 | 1 | 0 | 0 | 0 | 1 |
| Ex. 4 | 1 | 0 | 0 | 0 | 1 |
| Ex. 5 | 1 | 0 | 0 | 0 | 1 |
| Ex. 6 | 1 | 0 | 0 | 0 | 1 |
| Comp. Ex. 1 | 1 | 2 | 0 | 0 | 3 |
| Comp. Ex. 2 | 1 | 0 | 2 | 2* | 5 |
| Comp. Ex. 3 | 1 | 0 | 2 | 2* | 5 |
| Comp. Ex. 4 | 1 | 0 | 3 | 1 | 5 |

*Tearing also is not straight-edged, and shows fraying.

The evaluation clearly shows that excellent results are achieved in the critical performance tests with the product construction according to the invention.

In contrast to the comparative examples, the examples comprise paint-compatible, securely adhering, abrasion-resistant protective articles which are also readily processable owing to the ease of hand tearability and which are therefore highly suitable for the reliable protection and maintenance of value of painted plastic exterior mounted components for cars.

1. Self-adhesive article for the transit protection of painted car components such as, in particular, bumpers, which are subject to high mechanical stress, having a woven as backing material which is provided on one side in particular with a polyethylene-vinyl acetate self-adhesive composition.

2. Self-adhesive article according to claim 1, wherein the woven is coated with from 20 to 200 g/m², preferably from 50 to 150 g/m², of self-adhesive composition.

3. Self-adhesive article according to claim 1, wherein the woven is composed of cotton or viscose rayon staple.

4. Self-adhesive article according to claim 1, wherein the woven has a basis weight of from 30 to 300 g/m², preferably from 80 to 180 g/m².

5. Self-adhesive article according to claim 1, wherein in the case of the single-sidedly coated embodiment, which is preferred, the woven is treated on the side facing the adhesive with solutions, dispersions or reactive mixtures and/or the side of the woven facing the adhesive is treated with an adhesion promoter before being coated with the adhesive.

6. Self-adhesive article according to claim 1, wherein the vinyl acetate fraction in the polyethylene-vinyl acetate adhesive is from 40 to 90 per cent by weight and/or the melt index MFI according to ISO 1133 (A/4) of the polyethylene-vinyl acetate adhesive is from 0.5 to 25 g/10 min at 190° C. and 2.16 kg.

7. Self-adhesive article according to claim 1, wherein the self-adhesive composition is composed of two or more individual layers.

8. Self-adhesive article according to claim 1, wherein the self-adhesive article and in particular the adhesive is perforated.

9. The self-adhesive article according to claim 1, wherein as adhesive die cuts corresponding in shape to the intended application.

10. The self-adhesive article according to claim 1, for protecting surfaces which are particularly sensitive to impact and scratching, such as paint, metal, plastic or glass surfaces.

11. The self-adhesive article according to claim 1, on surfaces, especially curved surfaces, of cars.

12. The self-adhesive article according to claim 1, on curved surfaces on the outside of cars.

13. The self-adhesive article according to claim 1, on the paint finish of plastic car components such as, in particular, bumpers.
